(19) United States
(12) Patent Application Publication
(10) Pub. No.: US 2026/0180435 A1
(43) Pub. Date: Jun. 25, 2026

(54) CONTROL DEVICE

(71) Applicant: DENSO CORPORATION, Kariya-city (JP)

(72) Inventor: Kei SANADA, Kariya-city (JP)

(21) Appl. No.: 19/371,050

(22) Filed: Oct. 28, 2025

(30) Foreign Application Priority Data
Dec. 23, 2024 (JP) 2024-226654

(51) Int. Cl. H02M 1/32; H02M 1/00; H02M 1/084

(52) U.S. Cl. CPC H02M 1/325; H02M 1/0009; H02M 1/0845

(57) ABSTRACT

A control device includes a PWM control unit, a current detector, and a short circuit detector. The PWM control unit outputs a control signal to the driver of a multiphase power supply in which the inductors of each phase are configured by a coupled inductor, and controls an on/off of the driver. The current detector detects the current flowing through the driver. The short circuit detector detects an inter-inductor short circuit based on a switching cycle of the driver and a current value detected by the current detector. The short circuit detector determines that an inter-inductor short circuit occurs between phases including a given phase when a differential value of the current value corresponding to the given phase is positive and greater than or equal to a threshold value during an off period of the driver in the given phase.

### CROSS REFERENCE TO RELATED APPLICATIONS

This application is based on Japanese Patent Application No. 2024-226654 filed on Dec. 23, 2024, the description of which is incorporated herein by reference.

### TECHNICAL FIELD

The present disclosure relates to a control device.

### BACKGROUND

A control circuit for a DC/DC converter is known.

### SUMMARY

One object of the present disclosure is to provide a control device that can detect an inter-inductor short circuit in a coupled inductor.

A control device according to one aspect of the disclosure includes:
a control unit that outputs a control signal to a driver of a multiphase power supply having a plurality of phases each including a driver and an inductor, the inductor of each phase being configured by a coupled inductor, and controls an on/off of the driver;
a current detector that detects a current flowing in the driver; and
a short circuit detector that detects an inter-inductor short circuit of the coupled inductors based on a switching cycle of the driver and a current value detected by the current detector, wherein
the short circuit detector determines that an inter-inductor short circuit occurs between phases including a given phase when a differential value of the current value corresponding to the given phase is positive and greater than or equal to a threshold value during an off period of the driver in the given phase.

### BRIEF DESCRIPTION OF DRAWINGS

FIG. 1 is a diagram illustrating a control device according to a first embodiment;

FIG. 2 is a circuit diagram showing a multiphase power supply;

FIG. 3 is a perspective view showing a coupled inductor;

FIG. 4 is a perspective view showing a core;

FIG. 5 is a perspective view showing a coil;

FIG. 6 is a diagram showing an example of a short circuit between inductors;

FIG. 7 is a diagram showing PWM waveforms of each phase and a Vout1 waveform;

FIG. 8 is a block diagram showing a short circuit detector;

FIG. 9 is a flowchart showing a process executed by the short circuit detector;

FIG. 10 is a timing chart showing various signal waveforms in a state where no short circuit occurs between inductors;

FIG. 11 is a timing chart showing various signal waveforms when a short circuit occurs between inductors;

FIG. 12 is a block diagram showing a modified example of the short circuit detector;

FIG. 13 is a diagram showing a control device according to a second embodiment;

FIG. 14 is a flowchart showing a process executed by a short circuit detector in a control device according to a third embodiment;

FIG. 15 is a diagram showing a control device according to a fourth embodiment;

FIG. 16 is a diagram showing a modified example of the control device;

FIG. 17 is a diagram showing a modified example of the control device;

FIG. 18 is a diagram showing a Iout waveform and a Vout1 waveform in a normal state in a reference example;

FIG. 19 is a diagram showing a Iout waveform and a Vout1 waveform when a short circuit occurs between inductors in the reference example;

FIG. 20 is a flowchart showing a process executed by a processor in a control device according to a fifth embodiment; and

FIG. 21 is a flowchart showing a modified example.

### DETAILED DESCRIPTION

In an assumable example, a control circuit for a DC/DC converter is known. The disclosure of the document (Japanese Patent No. 6832082) is incorporated herein by reference as an explanation of the technical elements in this disclosure.

According to the document, it is possible to detect a short circuit in an inductor of each phase. However, in a configuration in which a multiphase power supply includes coupled inductors, it is not possible to detect a short circuit between inductors. Further improvements in control devices are required in the above respects and in other respects not mentioned.

One object of the present disclosure is to provide a control device that can detect an inter-inductor short circuit in a coupled inductor.

A control device according to one aspect of the disclosure includes:
a control unit that outputs a control signal to a driver of a multiphase power supply having a plurality of phases each including a driver and an inductor, the inductor of each phase being configured by a coupled inductor, and controls an on/off of the driver,
a current detector that detects a current flowing in the driver; and
a short circuit detector that detects an inter-inductor short circuit of the coupled inductors based on a switching cycle of the driver and a current value detected by the current detector, wherein
the short circuit detector determines that an inter-inductor short circuit occurs between phases including a given phase when a differential value of the current value corresponding to the given phase is positive and greater than or equal to a threshold value during an off period of the driver in the given phase.

According to the disclosed control device, when a short circuit occurs between an inductor of a given phase and an inductor of another phase, the differential value corresponding to the given phase becomes positive and greater than or equal to the threshold value even when the driver of the other phase is turned on. The short circuit detector determines that an inter-inductor short circuit has occurred between phases including the given phase when the differential value corresponding to the given phase is positive and greater than or equal to the threshold value during the off period of the driver in the given phase. Therefore, it is possible to detect a short circuit between the inductors of the coupled inductors.

The multiple embodiments disclosed in this description employ different technical means to achieve their respective objectives. The objects, features, and advantages disclosed in this description will become apparent by referring to following detailed descriptions and accompanying drawings.

Hereinafter, multiple embodiments will be described with reference to the drawings. The same reference numerals are assigned to the corresponding elements in each embodiment, and thus, duplicate descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

As will be described later, the control device according to the present embodiment includes at least a power supply control unit that controls a multiphase power supply including a coupled inductor. A control device that includes only a power supply control unit is a control device for a multiphase power supply. The control device may include a multiphase power supply in addition to the power supply control. In addition to the power supply control unit and the multiphase power supply, the control device may also include a load that operates by receiving power from the multiphase power supply. The load may include a processor. The control device, which includes the power supply control unit, the multiphase power supply, and the processor, is sometimes referred to as an ECU. ECU is an abbreviation of Electronic Control Unit.

The ECU can be applied to, for example, a mobile object. Mobile objects include vehicles such as engine-driven vehicles, hybrid vehicles, and motor-driven vehicles, flying objects such as drones and eVTOLs, ships, construction machinery, and agricultural machinery. The eVTOL is an abbreviation for electric Vertical Take-Off and Landing aircraft. For example, when applied to a vehicle, the ECU controls devices mounted on the vehicle.

### Control Devise

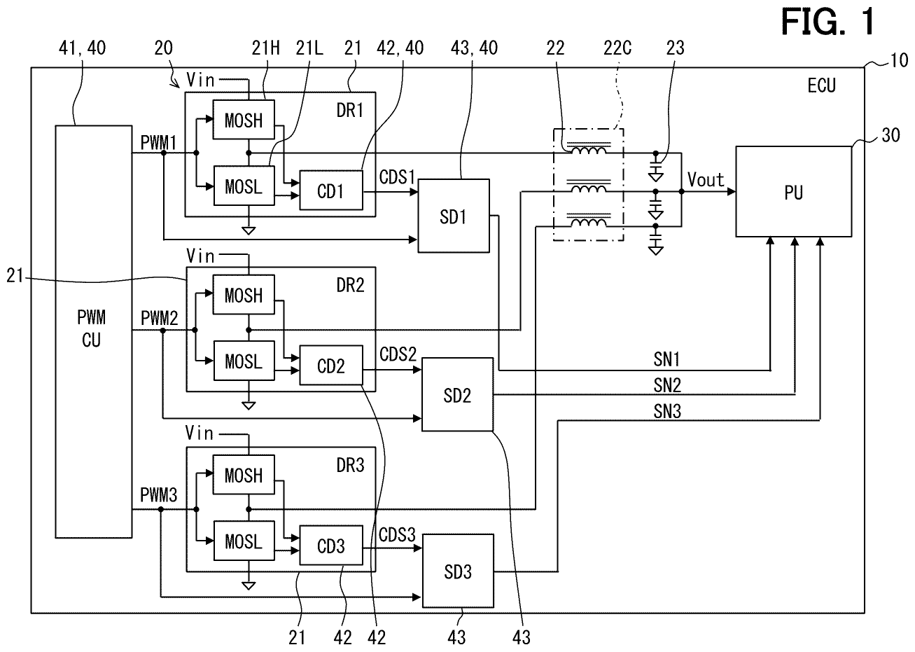

FIG. 1 shows an example of a control device according to the present embodiment. The illustrated control device 10 is an ECU mounted on a vehicle. The control device (ECU) 10 may be, for example, an automatic driving ECU or an ADAS ECU that executes control to assist the driver in driving operations. ADAS is an abbreviation for Advanced Driving Assistant System. For example, levels 3 to 5 as defined by the Society of Automotive Engineers (SAE International) correspond to automatic driving levels, while levels 1 to 2 correspond to driving assistance levels. The control device 10 may be an infotainment ECU or a cockpit ECU. A cockpit ECU is an ECU that controls devices such as a meter device, a navigation device, and an air conditioning device. The control device 10 may be, for example, an integrated ECU that integrates a plurality of control functions.

The control device 10 includes a multiphase power supply 20, a processor 30, and a power supply control unit 40. The control device 10 may include a processor 30 and a load separate from the processor 30.

### Multiphase Power Supply

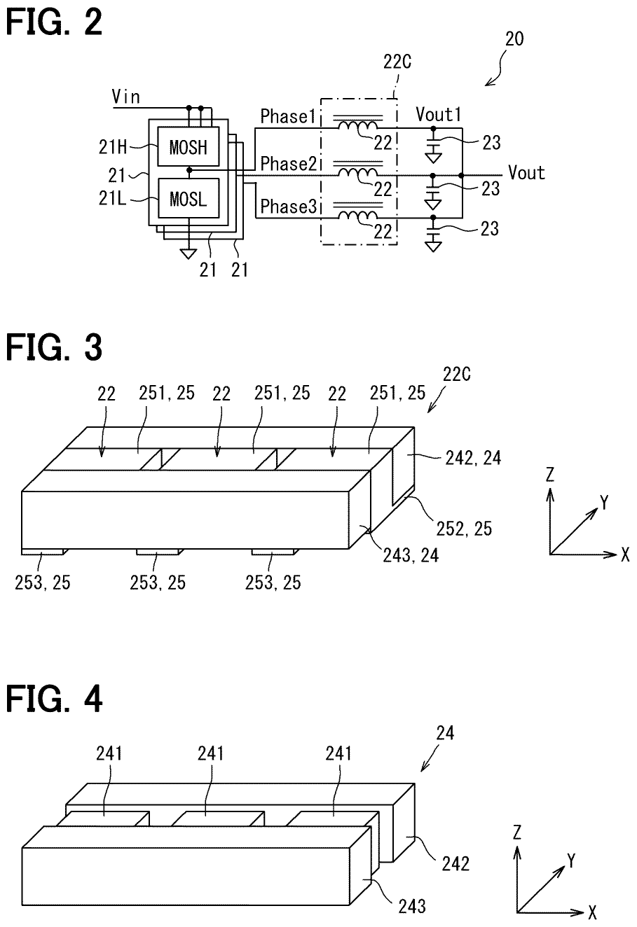

FIG. 2 is a circuit diagram showing a multiphase power supply. For convenience, some of the drivers are shown in a simplified form in FIG. 2. The multiphase power supply 20 is a power supply circuit provided within the control device 10. The multiphase power supply 20 steps down the input voltage to a predetermined voltage that can be supplied to a load such as the processor 30 and outputs the voltage. The multiphase power supply 20 is a step-down DC-DC converter. The multiphase power supply 20 steps down the input voltage Vin to a predetermined voltage (for example, around 1 V) and outputs it to the processor 30 load as an output voltage Vout.

The control device 10 may also include a primary power supply circuit (not shown) that, together with the multiphase power supply 20, constitutes a power supply circuit. The primary power supply circuit is configured to be able to step down an input voltage to a predetermined voltage and output the voltage. The primary power supply circuit is a step-down DC-DC converter. The primary power supply circuit generates a constant voltage (for example, 5 V) lower than the power supply voltage (+B) based on power supplied from, for example, a battery mounted on the vehicle. In a configuration including a primary power supply circuit, the multiphase power supply 20 is a secondary power supply circuit that receives the voltage generated by the primary power supply circuit as an input voltage Vin.

As shown in FIGS. 1 and 2, the multiphase power supply 20 includes a plurality of drivers (DRs) 21, a coupled inductor 22C having a plurality of inductors 22, and a capacitor 23. The multiphase power supply 20 has a plurality of phases, each including a driver 21 and an inductor 22. A phase may be referred to as a stage, a channel, etc. The number of phases is not particularly limited. The exemplary multiphase power supply 20 has three phases. In FIG. 2, the three phases are shown as Phase 1, Phase 2, and Phase 3. In FIG. 1, the number added to the end of DR indicates which phase it constitutes. For example, DR1 is the driver 21 that constitutes Phase 1.

The exemplary driver 21 includes MOSFETs 21H and 21L. MOSFET is an abbreviation for Metal Oxide Semiconductor Field Effect Transistor. Instead of the MOSFETs 21H and 21L, other switching elements such as IGBTs may be used. The IGBT is an abbreviation of an insulated gate bipolar transistor. The MOSFETs 21H and 21L are connected in series between a power supply line to which an input voltage Vin is input and a ground (GND) line, with the MOSFET 21H on a high side and the MOSFET 21L on a low side. In FIGS. 1 and 2, the MOSFET 21H on the high side is indicated as MOSH, and the MOSFET 21L on the low side is indicated as MOSL. The exemplary driver 21 has a drive circuit (not shown) that turns on and off the MOSFETs 21H and 21L based on a PWM signal (described later).

One end of the inductor 22 is connected to the connection point (node) of the MOSFETs 21H and 21L. The other end of the inductor 22 is connected to an output line. The inductor 22 is provided individually for the driver 21. The driver 21 and the inductor 22 of each phase are connected in parallel with each other. The parallel connection allows the output current, and therefore the load current, from the multiphase power supply 20 to be increased.

The capacitor 23 is connected to the output line. The positive terminal of the capacitor 23 is connected to the output line. The negative terminal of the capacitor 23 is connected to the ground. The capacitor 23 may be provided individually for each phase, or may be provided in common for a plurality of phases. In the exemplary multiphase power supply 20, a capacitor 23 is provided for each phase.

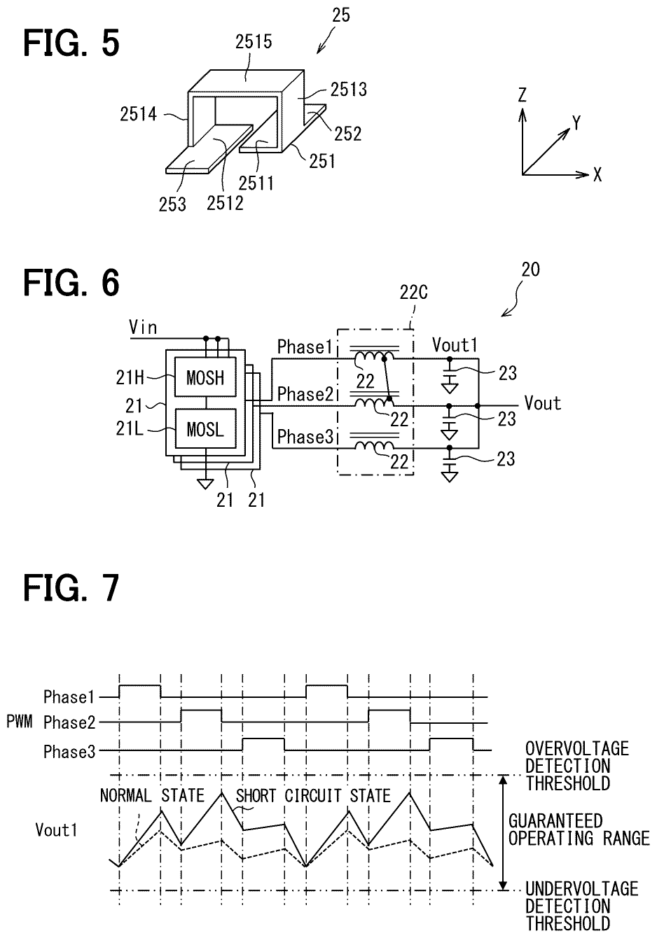

FIG. 3 is a perspective view showing an example of a coupled inductor. FIG. 4 is a perspective view showing the core. FIG. 5 is a perspective view showing the coil. A single coupled inductor 22C provides multiple inductors 22 that make up the multiphase power supply 20.

In the following description, the direction in which a plurality of coils are arranged is referred to as the X direction. A direction perpendicular to the X direction, in which the two end cores are arranged, is referred to as the Y direction. A direction perpendicular to both the X direction and the Y direction is referred to as the Z direction. Unless otherwise specified, a shape viewed in a plane from the Z-direction, that is, a shape along an XY plane defined by the X-direction and Y-direction is referred to as a planar shape. The plan view from the Z direction may be simply referred to as a plan view.

As shown in FIGS. 3 to 5, the coupled inductor 22C includes a core 24 and a plurality of coils 25. Each coil 25 constitutes an inductor 22. The plurality of coils 25 are arranged on one core 24, that is, a common core 24, and are magnetically coupled to one another. By using the coupled inductor 22C, magnetic fluxes between the phases can be cancelled out, and the effective inductance can be reduced.

The core 24 is formed using a magnetic material such as ferrite. The core 24 functions as a magnetic circuit. The core 24 has a plurality of central cores 241 and end cores 242 and 243. The core 24 may be made of a single member or may be made of a combination of multiple members. The core 24 has a coil 25 inserted therethrough. The central core 241 is provided individually for each coil 25. The coil 25 is wound around the central core 241. The central core 241 extends in the Y direction. The multiple central cores 241 are arranged in the X direction at predetermined intervals. The exemplary core 24 has three central cores 241. Each of the central cores 241 has a substantially rectangular parallelepiped shape. The three central cores 241 have the same shape.

The end cores 242 and 243 are disposed opposite each other in the Y direction. The end cores 242 and 243 sandwich the central core 241 therebetween. The end cores 242 and 243 extend in the X direction, which is the direction in which the multiple central cores 241 are arranged. One ends of the plurality of central cores 241 are connected to the end core 242, and the other ends of the plurality of central cores 241 are connected to the end core 243. The end cores 242 and 243 magnetically connect the plurality of central cores 241 together. The exemplary end cores 242 and 243 have the same shape. The end cores 242 and 243 are generally rectangular parallelepipeds with the X direction as the longitudinal direction.

The coil 25 is made of a metal material with good conductivity, such as copper. The coil 25 is formed by processing a metal plate material, rather than a metal wire material. The metal plate material is sometimes referred to as a metal frame. The plurality of coils 25 are made of the same material and have the same shape. The plurality of coils 25 have approximately the same inductance. The plurality of coils 25 are arranged in the X direction at predetermined intervals. The plurality of coils 25 are arranged in the same direction. The coil 25 is fixed to the core 24, for example, by adhesive. By placing the adjacent coils 25 closer to each other, the effect of canceling out the magnetic flux can be enhanced. That is, the effective inductance reduction effect can be improved.

The coil 25 is formed by bending a metal plate having a predetermined thickness. The coil 25 has a main body 251 and terminal portions 252 and 253. The terminal portions 252 and 253 are external connection terminals of the coil 25, and are soldered to lands on a substrate (not shown), for example. The thickness direction of the terminal portions 252 and 253 is approximately parallel to the Z direction. The upper surface, which is one of the plate surfaces of the terminal portion 252, faces the lower surface of the end core 242. The upper surface of the terminal portion 253 faces the lower surface of the end core 243.

The exemplary terminal portions 252 and 253 have a generally rectangular shape in plan view. The terminal portion 252 is connected to a bottom wall 2511 of the main body 251 and extends in the Y direction. The terminal portion 253 is connected to a bottom wall 2512 of the main body 251 and extends in the Y direction opposite to the terminal portion 252. The terminal portions 252 and 253 connected to the same main body 251 are arranged offset in the Y direction. The terminal portions 252 and 253 connected to the same main body 251 are arranged offset in the X direction. The terminal portion 252 has approximately the same length in the Y direction as the end core 242. The terminal portion 253 has approximately the same length in the Y direction as the end core 243. The terminal portions 252 and 253 may extend outward beyond the corresponding end cores 242 and 243 in the plan view.

The main body 251 is a portion wound around the central core 241. The main body 251 is a portion that overlaps with the central core 241 in the plan view. The main body 251 has bottom walls 2511 and 2512, side walls 2513 and 2514, and a top wall 2515.

A thickness direction of the bottom walls 2511 and 2512 is approximately parallel to the Z direction. The upper surface, which is one of the plate surfaces of the bottom walls 2511 and 2512, faces the lower surface of the central core 241. The exemplary bottom walls 2511 and 2512 have a generally rectangular shape in the plan view. A terminal portion 252 is connected to the end portion of the bottom wall 2511 in the Y direction. The bottom wall 2511 and the terminal portion 252 extend along the Y direction. The terminal portion 253 is connected to the end portion of the bottom wall 2512 in the Y direction. The bottom wall 2512 and the terminal portion 253 extend along the Y direction. The bottom walls 2511 and 2512 have approximately the same length as the central core 241 in the Y direction. The bottom walls 2511 and 2512 of one main body 251 are arranged side by side in the X direction at a predetermined interval.

The side wall 2513 is continuous with the bottom wall 2511. The side wall 2513 extends in the Z direction from the bottom wall 2511. The side wall 2513 faces one of the side surfaces of the central core 241. The exemplary side wall 2513 has a substantially rectangular shape when viewed in plan in the X direction. The side wall 2513 has approximately the same length in the Y direction as the bottom wall 2511. The side wall 2513 is bent at an angle of approximately 90 degrees relative to the bottom wall 2511. The thickness direction of the side wall 2513 is approximately parallel to the X direction. The lower end of the side wall 2513 is connected to the end of the bottom wall 2511 opposite to the end facing the bottom wall 2512.

Similarly, the side wall 2514 is continuous with the bottom wall 2512. The side wall 2514 extends in the Z direction from the bottom wall 2512. The side wall 2514 faces the side surface of the central core 241 opposite to the surface that the side wall 2513 faces. The exemplary side wall 2514 has a substantially rectangular shape when viewed in plan in the X direction. The side wall 2514 has approximately the same length in the Y direction as the bottom wall 2512. The side wall 2514 is bent at an angle of approximately 90 degrees relative to the bottom wall 2512. The thickness direction of the side wall 2514 is approximately parallel to the X direction. The lower end of the side wall 2514 is connected to the end of the bottom wall 2512 opposite to the end facing the bottom wall 2511.

The top wall 2515 bridges the side walls 2513 and 2514. The top wall 2515 extends in the X direction. One end of the top wall 2515 is continuous with the upper end of the side wall 2513, and the other end is continuous with the upper end of the side wall 2514. The top wall 2515 has the same length in the Y direction as the side walls 2513 and 2514. In the plan view, the top wall 2515 encompasses the entire areas of the side walls 2513 and 2514 and the bottom walls 2511 and 2512.

The bottom walls 2511 and 2512, the side walls 2513 and 2514, and the top wall 2515 surround the central core 241. The bottom walls 2511 and 2512, the side walls 2513 and 2514, and the top wall 2515 are attached to and wound around the central core 241. The end cores 242 and 243 are disposed on the terminal portions 252 and 253. In adjacent coils 25, one side wall 2513 of the coil 25 faces the other side wall 2514 of the coil 25.

The coupled inductor 22C may include a cover in addition to the core 24 and the plurality of coils 25. The cover is placed on the top surface of the core 24 so as to cover the core 24 and the plurality of coils 25. The cover is used, for example, to prevent foreign matter from adhering to the coupled inductor 22C. The cover is used for the purpose of preventing short circuits between the coils 25 due to, for example, conductive foreign matter. The cover is used, for example, to improve the adhesiveness during transportation when the coupled inductor 22C is mounted on a substrate. The material for the cover is not particularly limited as long as the above object can be achieved. For example, it may be made of a resin or a magnetic material.

### Processor

A processor (PU) 30 is an example of a load that operates by receiving a supply of power (electric power) from the multiphase power supply 20. The processor 30 is, for example, a CPU, a GPU, or the like. The CPU is an abbreviation of a central processing unit. The GPU is an abbreviation of a graphics processing unit. The control device 10 may include only one processor 30 or multiple processors 30. The control device 10 may include multiple types of processors 30. The processor 30 may be provided as a SoC or SiP. An SoC is a single semiconductor chip on which multiple components are mounted to realize the functions of a system or device. The SoC is an abbreviation of a system on chip. The SiP is an abbreviation for System in Package.

The processor 30 executes a control program stored in a memory (not shown) to perform predetermined processing for control. The memory is a non-transitory tangible storage medium that non-temporarily stores computer-readable programs, data, and the like.

A core voltage of the processor 30 is around 1[V] (for example, less than 1[V]), and the load current is several tens of amperes or more (for example, 100 [A] or more). In order to accommodate such low voltages and large currents, the control device 10 includes the multiphase power supply 20 as a power supply circuit. The multiphase power supply 20 steps down the input voltage to a voltage corresponding to the core voltage of the processor 30 and outputs the voltage. By using the multiphase power supply 20, it is possible to accommodate the increased performance of the processor 30 that accompanies improvements in autonomous driving levels and the evolution of infotainment functions, and in particular to accommodate autonomous driving levels 3 and above.

In a high-performance processor 30, the current consumption fluctuates suddenly in response to the calculation processing, so many capacitors 23 are required so that a stable voltage can be supplied even when the load suddenly changes. By using the coupled inductor 22C, the effective inductance value can be reduced as described above, and therefore the responsiveness to sudden load changes is improved. This allows the capacitor 23 to be significantly reduced compared to a configuration using a normal single inductor. For example, the size of the multiphase power supply 20, and therefore the size of the control device 10, can be reduced.

### Power Supply Control Unit

The power supply control unit 40 controls the multiphase power supply 20. As shown in FIG. 1, the power supply control unit 40 includes a PWM control unit (PWMCU) 41.

The PWM control unit 41 outputs a control signal to the driver 21 to control the on/off of the driver 21. The power supply control unit 40 performs voltage mode control by, for example, feedback of the output voltage Vout, and controls the operation of the driver 21, that is, the operation of the MOSFETs 21H and 21L. The power supply control unit 40 determines the pulse width (duty ratio) of a PWM signal, which is a control signal, based on the output voltage Vout, and controls the output voltage Vout of the multiphase power supply 20. The power supply control unit 40 may execute current mode control instead of voltage mode control. In FIG. 1, the PWM signal is indicated as PWM. The number added to the end of PWM indicates which phase it corresponds to.

The power supply control unit 40 controls the plurality of drivers 21 in synchronization with each other so that the plurality of drivers 21 perform switching operations at different phases. By using a plurality of phases in this way, it is possible to increase the switching frequency artificially even if the switching frequencies of the plurality of drivers 21 are the same. This makes it possible to reduce the ripple component of the output voltage Vout and improve the responsiveness. The power supply control unit 40 switches the driver 21 to perform the switching operation, that is, the number of drive phases, depending on the load current. The power supply control unit 40 compares the load current with a threshold current, and increases and/or decreases the number of driving phases depending on the comparison result.

The power supply control unit 40 detects a short circuit that occurs between the inductors 22 of the coupled inductor 22C that constitutes the multiphase power supply 20, that is, between the coils 25. The power supply control unit 40 includes a current detector (CD) 42 and a short circuit detector (SD) 43. In FIG. 1, the numbers added to the end of CD and SD indicate which phase it corresponds to. For example, CD1 is a current detector 42 that detects the current flowing through the driver (DR1) 21 of Phase 1. SD1 is a short circuit detector 43 that acquires a current detection signal from the current detector 42 (CD1) corresponding to Phase 1.

The current detector 42 detects the current flowing through the driver 21. The current detector 42 detects the current flowing through each of the drivers 21. The exemplary current detector 42 is provided separately for the driver 21. The means for detecting the current is not particularly limited. The current detector 42 may be provided integrally with the driver 21 or may be provided separately from the driver 21. The current detector 42 is a current sensor provided on the same semiconductor chip as the MOSFETs 21H and 21L that form the driver 21, for example. The current detector 42 detects the current flowing through the driver 21 of the corresponding phase, and outputs a current detection signal (CDS) to the corresponding short circuit detector 43. The number added to the end of the CDS indicates which phase it corresponds to.

The short circuit detector 43 detects an inter-inductor short circuit in the coupled inductor 22C based on the switching cycle of the driver 21 and the current value (current detection signal) detected by the current detector 42. The short circuit detector will be described in detail later.

### Short Circuit Between Inductors

FIG. 6 is a diagram showing an example of an inter-inductor short circuit. As described above, in the coupled inductor 22C, a plurality of coils 25, that is, a plurality of inductors 22, are arranged in a predetermined direction (X direction). In addition, in order to strengthen the magnetic coupling and reduce the effective inductance, the distance between adjacent coils 25 is made very narrow. Therefore, there is a risk of short circuits occurring between adjacent inductors due to the inclusion of conductive foreign matter, ion migration, or the like.

In FIG. 6, a short circuit occurs between the inductor 22 of Phase 1 and the inductor 22 of Phase 2 out of the three phases. Vout1 shown in FIG. 6 is the output voltage of Phase 1.

FIG. 7 is a diagram showing the PWM waveforms of each phase and the Vout1 waveform. In FIG. 7, the ON period of a predetermined duty ratio is shown in a simplified manner. The PWM waveform shows the on and off periods. That is, it indicates a switching cycle. Of the output voltage Vout1, the dashed line indicates the waveform in a normal state, and the solid line indicates the waveform in a short circuit state. The solid line indicates the waveform when a short circuit occurs between the inductors of Phase 1 and Phase 2, as shown in FIG. 6. The two-dot chain lines for the output voltage Vout1 indicate the overvoltage detection threshold and the undervoltage detection threshold. The guaranteed operation range is between the undervoltage detection threshold and the overvoltage detection threshold.

In the normal state, the output voltage Vout1 rises significantly during the ON period of Phase1. Due to the influence of magnetic coupling, the output voltage Vout1 also rises during the ON period of Phase 2 and the ON period of Phase 3. The rises during the ON period of Phase 2 and the ON period of Phase 3 are smaller than the rise during the ON period of Phase 1.

When an inter-inductor short circuit occurs, the output voltage Vout1 rises significantly during the ON period of Phase 1 and the ON period of Phase 2. Due to the influence of magnetic coupling, the output voltage Vout1 rises even during the ON period of Phase 3. The rise in the output voltage Vout1 during the ON period of Phase 3 is smaller than the rise in voltage during the ON period of Phase 1 and the rise in voltage during the ON period of Phase 2. Although the ripple fluctuation increases by approximately two times due to the inter-inductor short circuit, there are almost no cases where the ripple fluctuation reaches the overvoltage detection threshold. In other words, the inter-inductor short circuit cannot be detected using the overvoltage detection threshold or undervoltage detection threshold used in general fault diagnosis.

### Short Circuit Detector

The power supply control unit 40 illustrated in FIG. 1 includes a plurality of short circuit detectors 43. The exemplary short circuit detector 43 is provided individually for each phase. The power supply control unit 40 includes three short circuit detectors 43.

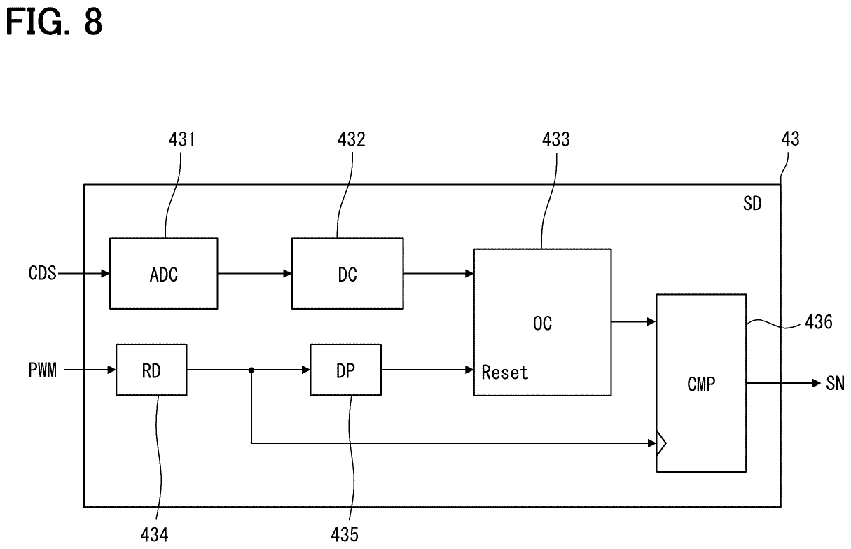

FIG. 8 is a block diagram showing the short circuit detector. FIG. 8 illustrates one of the multiple short circuit detectors. The plurality of short circuit detectors 43 have the same configuration. The short circuit detector 43 detects an inter-inductor short circuit in the coupled inductor 22C as described above. At least a part of the functions of the short circuit detector 43 may be realized by hardware, or at least a part of the functions may be realized by software. The short circuit detector 43 may include, for example, an analog circuit or a digital circuit. The short circuit detector 43 includes an A/D converter (ADC) 431, a differential calculator (DC) 432, an on-count counter (OC) 433, a rising edge detection unit (RD) 434, a delay unit (DP) 435, and a comparator (CMP2) 436.

The A/D converter 431 acquires the current value detected by the current detector 42 of the corresponding phase, that is, the current detection signal (CDS), and converts it into a digital signal. The A/D converter 431 outputs the current value converted into a digital signal to the differential calculator 432.

The differential calculator 432 performs a differential calculation on the output of the A/D converter 431, that is, the current value. The differential calculator 432 outputs the calculation result to the on-count counter 433. The rising edge detection unit 434 acquires the PWM signal of the corresponding phase and detects the rising edge of the ON timing. The delay unit 435 delays the rising timing detected by the rising edge detection unit 434 by a predetermined time and outputs the delayed rising timing to the on-count counter 433.

Based on the calculation result of the differential calculator 432, the on-count counter 433 counts how many times a current gradient corresponding to when the driver 21 of the corresponding phase is turned on occurs within a switching cycle. The on-count counter 433 resets the count based on the rising edge of the PWM signal acquired through the rising edge detection unit 434 and the delay unit 435. The on-count counter 433 resets the count at the start of the next switching cycle.

In a normal state where no short circuit occurs between the inductors, the on-count counter 433 counts only when the driver 21 of the corresponding phase is turned on. Therefore, the count number of the on-count counter 433 becomes one. On the other hand, when an inter-inductor short circuit, that is, a short circuit between coils occurs, the on-count counter 433 counts at the timing when the driver 21 of the corresponding phase is turned on and at the timing when the driver 21 on the short circuit side is turned on. Therefore, the count number of the on-count counter 433 becomes 2. Furthermore, if there are many short circuits, the count number increases by the number of short circuits.

The comparator 436 is provided at the final stage of the short circuit detector 43. The comparator 436 compares the count number of the on-count counter 433 with the on-count threshold value THn, and outputs the comparison result. In the exemplary comparator 436, the on-count threshold value THn is two. When the count number is equal to or greater than the on-count threshold value THn, the comparator 436 turns on the fault notification. The comparator 436 outputs a fault notification (SN) to the processor 30. The turn on fault notification indicates that a short circuit has occurred between the inductors. When the count number is less than the on-count threshold value THn, the comparator 436 turns off the fault notification. The turn off fault notification indicates that no short circuit has occurred between the inductors and that the system is normal. The comparator 436 acquires the rising edge timing of the PWM signal from the rising edge detection unit 434, and at the start timing of the next switching cycle, determines whether there is a short circuit between the inductors in the immediately preceding switching cycle.

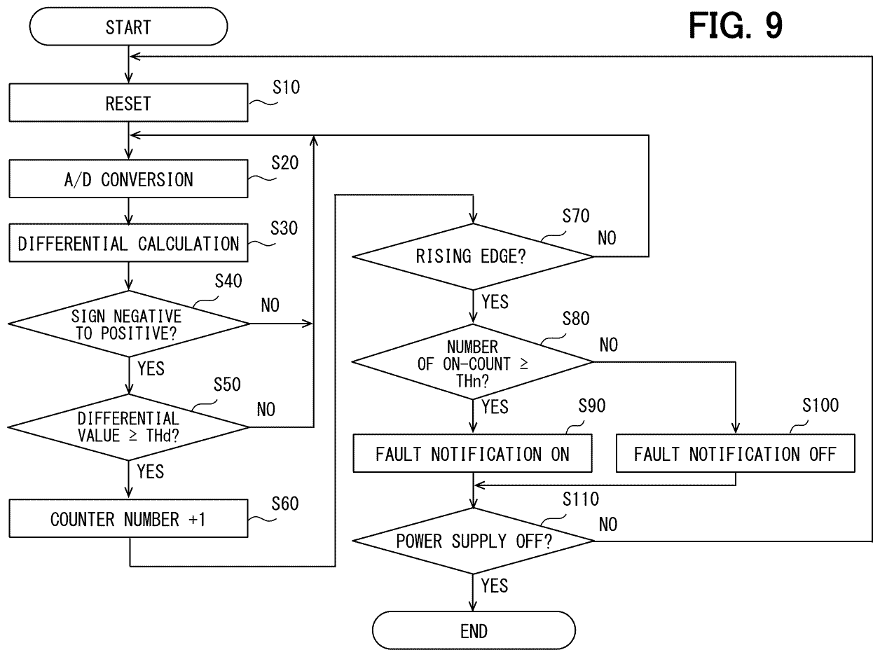

FIG. 9 is a flowchart showing an example of a short circuit detection process executed by the short circuit detector. For example, when power is supplied and the short circuit detector 43 is started up, the short circuit detector 43 executes a short circuit detection process.

First, the short circuit detector 43 resets the on-count counter 433 (step S10). The exemplary short circuit detector 43 resets the count number of the on-count counter 433 to zero (0).

Next, the short circuit detector 43 performs A/D conversion of the current detection signal (step S20). The A/D converter 431 acquires the current detection signal of the corresponding phase from the corresponding current detector 42 and performs A/D conversion.

Next, the short circuit detector 43 performs a differential calculation of the current value (step S30). The differential calculator 432 differentiates the current value output from the A/D converter 431. The differential value obtained by the calculation corresponds to the gradient of the current.

As shown in the timing chart described later, the differential value (slope) becomes positive when the PWM signal is turned on, and becomes negative when the PWM signal is turned off. Next, the short circuit detector 43 determines whether the sign of the differential value has changed from negative to positive (step S40), and when it has changed to positive, determines whether the differential value is equal to or greater than the threshold value THd (step S50). The on-count counter 433 determines whether the current gradient corresponds to the on state of the corresponding driver 21 at the timing when the sign of the differential value switches from negative to positive.

When the differential value is equal to or greater than the threshold value THd, the short circuit detector 43 then increments the count number of the on-count counter 433 by +1 (step S60). The on-count counter 433 increments the on-count when the differential value (slope) is equal to or greater than the threshold value THd at the timing when the differential value changes from negative to positive. When the differential value does not change from negative to positive in step S40, the short circuit detector 43 returns to step S20 and executes the processes from step S20 onwards again. Similarly, when the differential value is less than the threshold value THd in step S50, the short circuit detector 43 executes the processes from step S20 onwards again.

Next, the short circuit detector 43 determines whether it is the rising edge timing of the corresponding PWM signal (step S70). The comparator 436 acquires the rising edge timing of the PWM signal from the rising edge detecting unit 434 and determines whether it is the start timing of the next switching cycle. When it is not the rising edge timing, the short circuit detector 43 executes the processes from step S20 onwards again.

At the rising edge timing, that is, at the start timing of the next switching cycle, the short circuit detector 43 then determines whether the number of on-count is equal to or greater than the on-count threshold value THn (step S80). When the number of on-count is equal to or greater than the on-count threshold value THn, the fault notification is turned on (step S90). When the number of on-count is less than the on-count threshold THn, the fault notification is turned off (step S100).

The exemplary comparator 436 determines whether the number of on-count obtained from the on-count counter 433 is equal to or greater than 2, which is the on-counter threshold value THn. The comparator 436 turns on the fault notification when the number of on-count is two or more, and turns off the fault notification when the number of on-count is less than two. For example, the comparator 436 outputs an H level signal corresponding to the fault notification when the number of on-count is two or more, and outputs an L level signal when the number of on-count is less than two.

Next, the short circuit detector 43 determines whether the power supply to the short circuit detector 43 is off (step S110). When the power supply is off, the short circuit detection process ends. When the power supply is not off, the short circuit detector 43 executes the processes from step S10 onwards again. Since one period of the switching cycle has ended, the number of on-count of the on-count counter is reset in step S10.

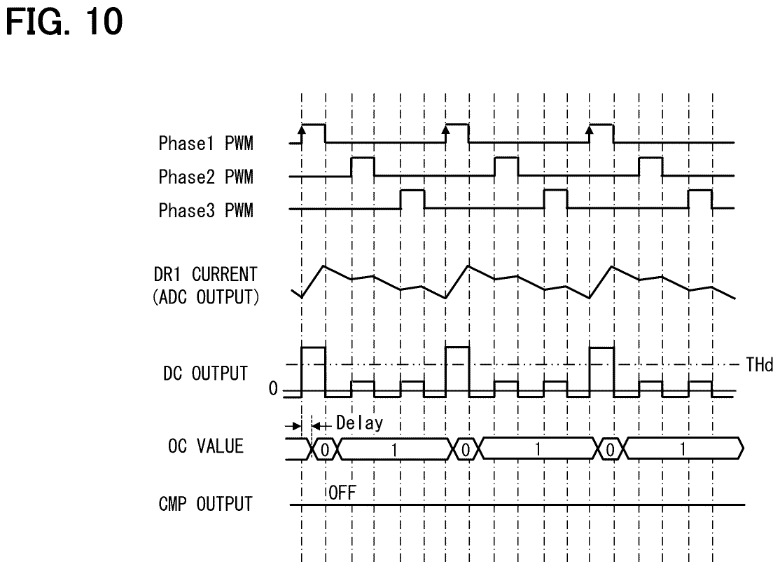

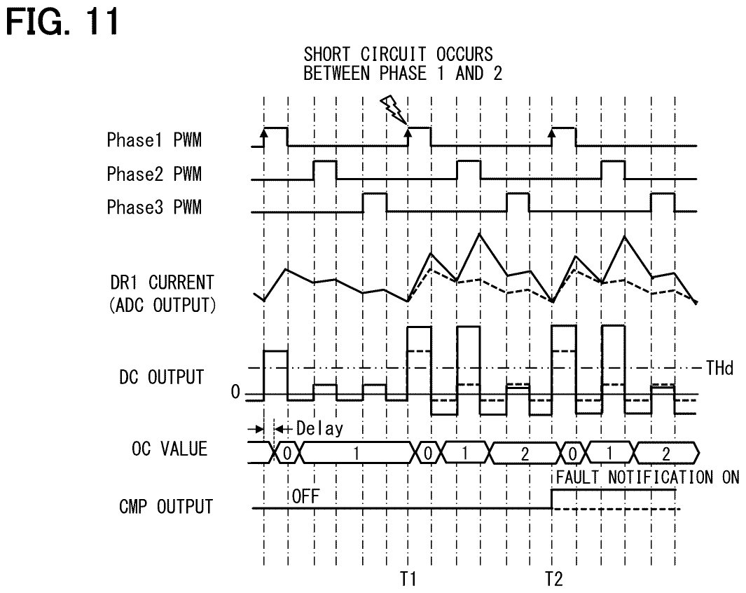

FIG. 10 is a timing chart showing an example of various signal waveforms in a state where no short circuit occurs between inductors. FIG. 11 is a timing chart showing an example of various signal waveforms in a state where the short circuit occurs between inductors. FIGS. 10 and 11 show the PWM waveforms of each phase and the output waveform of the element of the short circuit detector 43 corresponding to Phase 1. Specifically, in the short circuit detector (SD1) 43 corresponding to Phase 1, the elements include the current of the driver (DR1) 21, which is the output of the A/D converter (ADC) 431, the output of the differential calculator (DC) 432, the count number of the on count counter (OC) 433, and the fault notification, which is the output of the comparator (CMP) 436, are shown. In FIGS. 10 and 11, similar to FIG. 7, the ON period of a predetermined duty ratio is shown in a simplified manner.

As shown in FIG. 10, when no short circuit has occurred between the inductors, the short circuit detector 43 corresponding to Phase 1 executes a predetermined process based on the PWM signal that drives the driver (DR1) 21 of Phase 1. At the ON timing of the PWM signal of Phase 1, the current flowing through the driver 21 increases rapidly with a positive slope. As a result, the differential value output from the differential calculator 432 switches from negative to positive, and the differential value becomes equal to or greater than the threshold value THd. The count number (OC value) of the on-count counter 433 is reset a predetermined time after the rising edge of the PWM signal of Phase 1, and then starts counting. The count number of the on-count counter becomes 1 after a predetermined time delay.

At the off timing of the PWM signal of Phase 1, the differential value indicates a negative value. However, by using the coupled inductor 22C, the inductors 22 of each phase are magnetically coupled to each other, so that the sign of the differential value switches from negative to positive even when the PWM signals of Phases 2 and 3 are turned on. However, the gradient of the current due to magnetic coupling is small compared to the gradient of the current when the short circuit has occurred between the inductors, and the differential value is less than the threshold value THd. At the next ON timing of the Phase 1 PWM signal, the counter number of the on-count counter 433 is reset to 0. When no short circuit occurs between the inductors, the count number of the on-count counter 433 alternates between 0 and 1. Therefore, the comparator 436 always outputs a signal at the L level. In other words, the fault notification signal is maintained in the OFF state.

FIG. 11 shows waveforms when the short circuit occurs between the inductor 22 of Phase 1 and the inductor 22 of Phase 2 at timing T1. Here, an example is shown in which the short circuit occurs between the corresponding ends of the inductors 22 on the driver 21 side. When the short circuit occurs between the inductors of Phase 1 and Phase 2 at timing T1, a current flows through the inductor 22 of Phase 1 even during the ON period of Phase 2. After timing T1, the current flowing through the driver 21 of Phase 1 increases rapidly when Phases 1 and 2 are turned on. As a result, the count number of the on-count counter 433 becomes 2 in one period of the switching cycle.

At timing T2, which is the rising edge of the next on timing of the PWM signal of Phase 1, the comparator 436 compares the count number with the on-count threshold value THn, and determines that the count number is equal to or greater than the on-count threshold value THn, which is 2. The comparator 436 outputs an H level signal at timing T2. That is, the fault notification signal is turned on. The count number of the on-count counter 433 is reset to 0 after a predetermined time delay from timing T2. While the short circuit occurs between the inductors, the comparator 436 maintains the fault notification signal in an ON state.

Similar waveforms are shown for other phases. In the case of the short circuit detector 43 corresponding to Phase 2, a predetermined process is executed based on the PWM signal that drives the driver (DR2) 21 of Phase 2. The count number of the on-count counter 433 is reset a predetermined time after the rising edge of the PWM signal of Phase 2, and then starts counting. At the rising edge of the next ON timing of the PWM signal of Phase 2, the comparator 436 compares the count number with the ON count threshold value THn. As described above, when the short circuit occurs between the inductors in Phase 1 and Phase 2, a current flows through the inductor 22 in Phase 2 even during the ON period of Phase 1. As a result, the count number of the on-count counter 433 becomes 2 during one period of the switching cycle, and the fault notification signal turns on.

Similarly, in the case of the short circuit detector 43 corresponding to Phase 3, a predetermined process is executed based on the PWM signal that drives the driver (DR3) 21 of Phase 3. The count number of the on-count counter 433 is reset a predetermined time after the rising edge of the PWM signal of Phase 3, and then starts counting. At the rising edge of the next ON timing of the PWM signal of Phase 3, the comparator 436 compares the count number with the ON count threshold value THn.

### Overview of First Embodiment

The control device 10 of the present embodiment includes a power supply control unit 40 (power supply control device) that controls the multiphase power supply 20 having a PWM control unit 41 that controls the on/off of the driver 21 of the multiphase power supply 20, a current detector 42 that detects the current flowing through the driver 21, and a short circuit detector 43. The short circuit detector 43 detects an inter-inductor short circuit in the coupled inductor 22C based on the switching cycle of the driver 21 and the current value detected by the current detector 42. The PWM control unit 41 corresponds to a control unit that controls the on/off of the driver 21.

When a short circuit occurs between the inductor 22 of any phase and the inductor 22 of other phase, current flows through the inductor 22 of the any phase even during the on period of the driver 21 of the other phase, and the differential value corresponding to the any phase becomes positive and greater than or equal to the threshold value. The short circuit detector 43 determines that an inter-inductor short circuit has occurred between phases including the given phase when the differential value corresponding to the given phase is positive and greater than or equal to the threshold value THd during the off period of the driver 21 in the given phase. Therefore, the control device 10 can detect an inter-inductor short circuit in the coupled inductor 22C.

As shown in the example, the short circuit detector 43 may determine whether there is an inter-inductor short circuit based on the number of times that the differential value becomes positive and equal to or greater than the threshold value THd during one period of the switching cycle. As described above, when an inter-inductor short circuit occurs, a current flows through the inductor 22 of a given phase even during the on-period of the driver 21 of other phase, and the differential value corresponding to the given phase becomes positive and equal to or greater than the threshold value THd. As a result, the differential value becomes positive and equal to or greater than the threshold value THd multiple times in one period. Therefore, the presence or absence of an inter-inductor short circuit can be determined based on the number of times in a predetermined period.

As shown in the example, the threshold value THd may be set to a predetermined value greater than the differential value corresponding to any phase when the driver 21 of any phase other than the given phase is turned on when no short circuit occurs between the inductors. In the coupled inductor 22C, the current of given phase exhibits a positive slope during the ON period of the other phase due to magnetic coupling. By setting the threshold value THd as described above, it is possible to suppress erroneous determination and improve the accuracy of detecting the short circuit between inductors.

As shown in the example, the short circuit detector 43 may detect one period of a plurality of phases based on the control signal from the driver 21. This allows the process to be performed based on the control signal. For example, the presence or absence of an inter-inductor short circuit can be determined based on the number of times in a predetermined period.

As shown in the example, the control device 10 may further include a multi-phase power supply 20 and a processor 30 in addition to the power supply control unit 40. The control device 10 can function as an electronic control unit (ECU).

### Modification Example

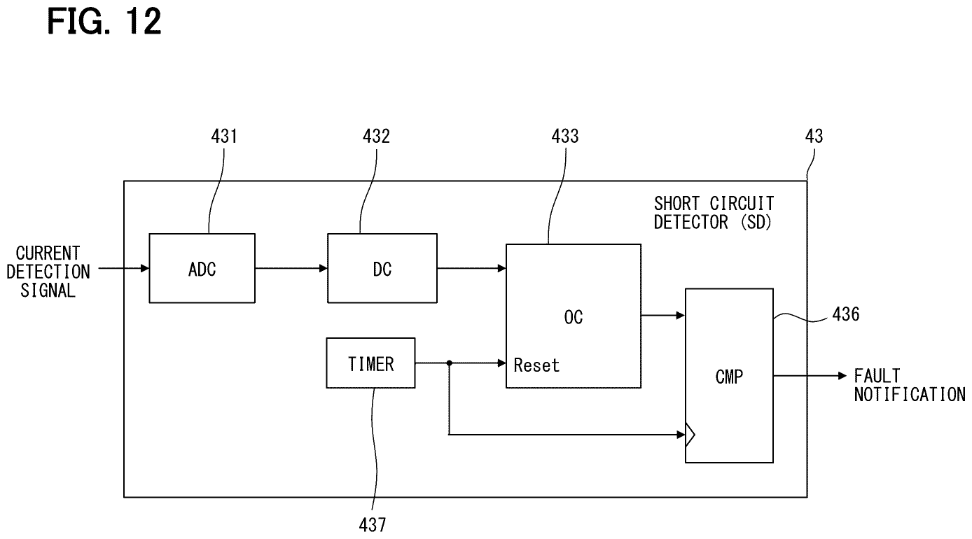

As shown in FIG. 12, the short circuit detector 43 may include a timer 437. The timer 437 counts the switching cycle of the corresponding phase. The output of the timer 437 can be used to reset the on-count counter 433 and to execute the judgment of the comparator 436. By using the timer 437, a PWM signal (control signal) becomes unnecessary. This makes it possible to reduce the number of connection interfaces between the short circuit detector 43 and the peripheral units.

### Second Embodiment

A second embodiment is a modification of the preceding embodiment as a basic configuration and may incorporate description of the precedent embodiments. In the preceding embodiment, the short circuit detector is provided for each phase. That is, the same number of short circuit detectors as the number of drivers are provided. Alternatively, the number of short circuit detectors may be one less than the number of drivers.

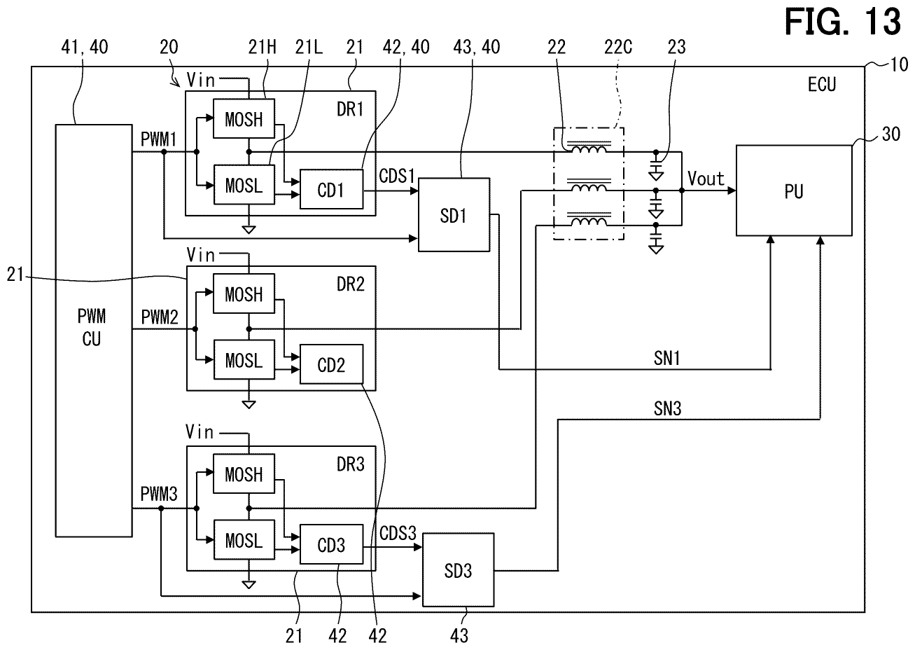

FIG. 13 is a diagram illustrating an example of a control device according to the present embodiment. FIG. 13 corresponds to FIG. 1. The control device 10 includes a power supply control unit 40. The multiphase power supply 20 has three phases. The multiphase power supply 20 has three drivers 21. The short circuit detector 43 includes a short circuit detector (SD1) 43 corresponding to Phase 1 and a short circuit detector (SD3) 43 corresponding to Phase 3. The short circuit detector 43 does not include a short circuit detector (SD2) 43 corresponding to Phase 2. The other configurations are the same as those described in the previous embodiment.

Overview of second embodiment:
As illustrated, the number of short circuit detectors 43 may be one less than the number of drivers 21. When the number of drivers 21, that is, the number of phases, is N, then even if the number of short circuit detectors 43 is N-1, it is possible to detect an inter-inductor short circuit. This simplifies the configuration while achieving the same effect as a configuration in which the same number of short circuit detectors 43 as the number of drivers 21 are provided.

### Third Embodiment

A second embodiment is a modification of the preceding embodiment as a basic configuration and may incorporate description of the precedent embodiments. In the previous embodiment, the differential value itself was used. Alternatively, the average value of the differential values may be used as the differential value.

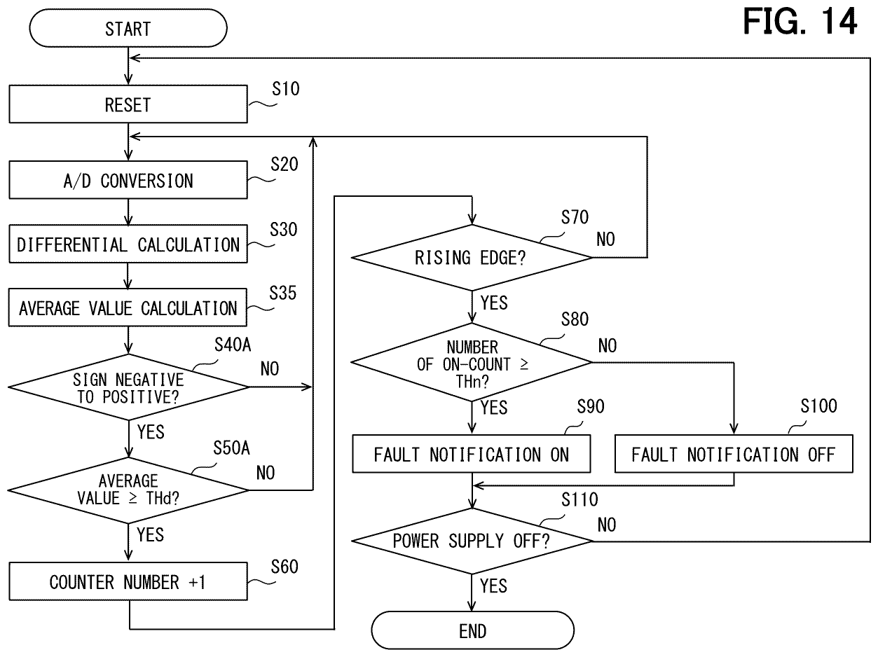

FIG. 14 is a flowchart showing an example of process executed by the short circuit detector in the control device according to the present embodiment. FIG. 14 corresponds to FIG. 9. The configuration of the short circuit detector 43 is the same as that of the preceding embodiment. As shown in FIG. 14, the processes of steps S10, S20, S30, S40, S60, S70, S80, S90, S100, and S110 are the same as those in the preceding embodiment.

After executing the process of step S30, the short circuit detector 43 then calculates the average value of the differential values (step S35). The average value is the average value of the differential values over a predetermined period. The predetermined period is a period shorter than one switching cycle. The predetermined period may be, for example, a period shorter than the ON period of the corresponding phase.

Next, the short circuit detector 43 determines whether the sign of the average value calculated in step S35 has changed from negative to positive (step S40A). When the sign has changed to positive, the short circuit detector 43 then determines whether the average value is equal to or greater than the threshold value THd (step S50A).

When the average value of the differential values is equal to or greater than the threshold value THd, the short circuit detector 43 then executes the process of step S60. When the sign of the average value does not change from negative to positive in step S40A, the short circuit detector 43 executes the processes from step S20 onwards again. Similarly, when the average value is less than the threshold value THd in step S50A, the short circuit detector 43 executes the processes from step S20 onwards again.

The differential calculator 432 may calculate the average value of the differential values and output the average value. The on-count counter 433 may calculate the average value of the differential values. An average value calculation unit may be provided between the differential calculator 432 and the on-count counter 433 to hold the output of the differential calculator 432 for a predetermined period and calculate an average value. The other configurations are the same as those described in the previous embodiment.

### Overview of Third Embodiment

As illustrated, the short circuit detector 43 may use an average value of the differential values over a predetermined period shorter than one switching cycle to determine whether the differential value is positive and equal to or greater than a threshold value. This can reduce erroneous determinations due to noise. In other words, the accuracy of detecting an inter-inductor short circuit can be improved. For example, even if the sign of the differential value changes due to the influence of noise, the use of the average value can reduce erroneous determination of the change in sign. For example, even if the differential value momentarily exceeds the threshold value THd due to the influence of noise, the use of the average value can reduce erroneous determinations of the threshold value THd.

### Fourth Embodiment

A second embodiment is a modification of the preceding embodiment as a basic configuration and may incorporate description of the precedent embodiments. In the preceding embodiments, the short circuit detector is provided separately from the other elements that configure the control device. Alternatively, the short circuit detector may be provided integrally with other elements that constitute the control device.

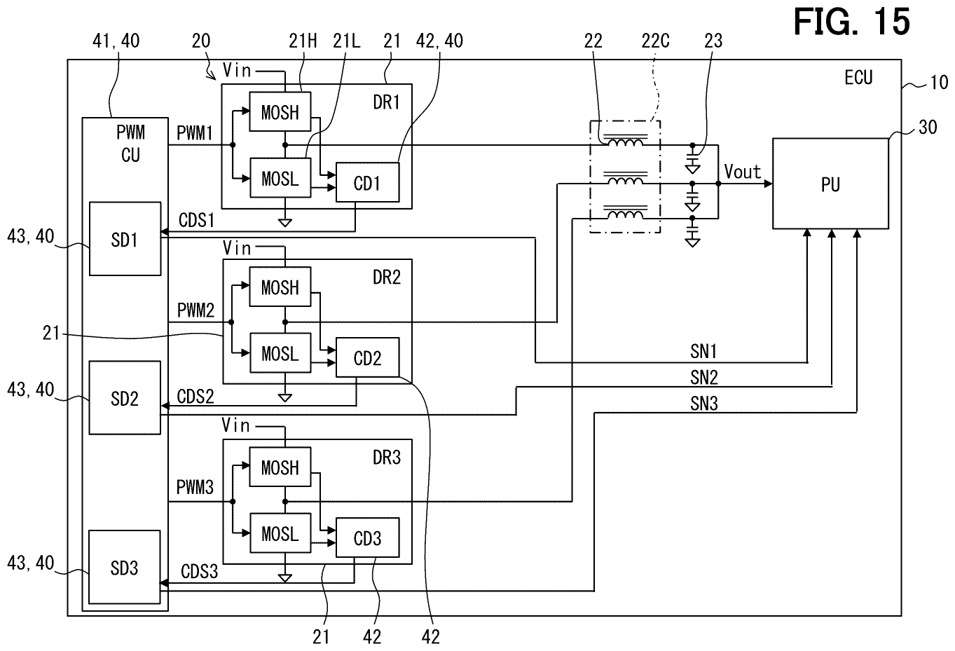

FIG. 15 is a diagram illustrating an example of a control device according to the present embodiment. FIG. 15 corresponds to FIG. 1. In the power supply control unit 40 of the control device 10, the short circuit detector 43 is provided in the PWM control unit 41. The short circuit detector 43 is provided integrally with the PWM control unit 41. In the exemplary control device 10, three short circuit detectors 43 corresponding to the three phases are provided in one PWM control unit 41. The other configurations are the same as those described in the previous embodiment.

### Overview of Fourth Embodiment

As illustrated, the short circuit detector 43 may be provided in the PWM control unit 41. The PWM control unit 41 corresponds to a control unit that controls the on/off of the driver 21. By providing the short circuit detector 43 within the PWM control unit 41, the configuration of the power supply control unit 40, and therefore the control device 10, can be simplified compared to a configuration using discrete components. Moreover, the short circuit detector 43 can be constructed inexpensively.

### Modification Example

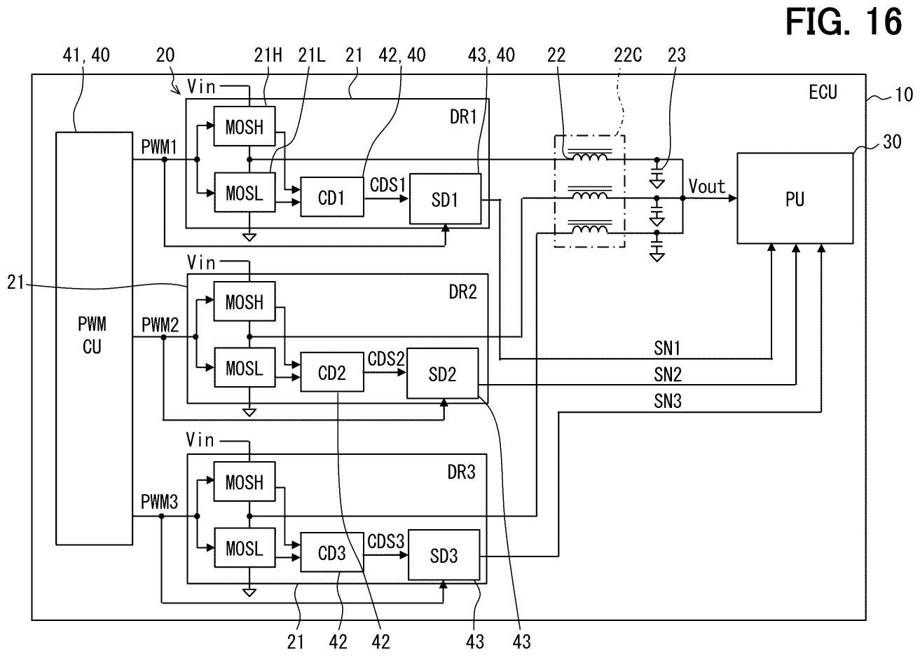

As shown in FIG. 16, the short circuit detector 43 may be provided in the driver 21. By providing the short circuit detector 43 in the driver 21 of the corresponding phase, the configuration of the control device 10 can be simplified compared to a configuration using discrete components. Moreover, the short circuit detector 43 can be constructed inexpensively.

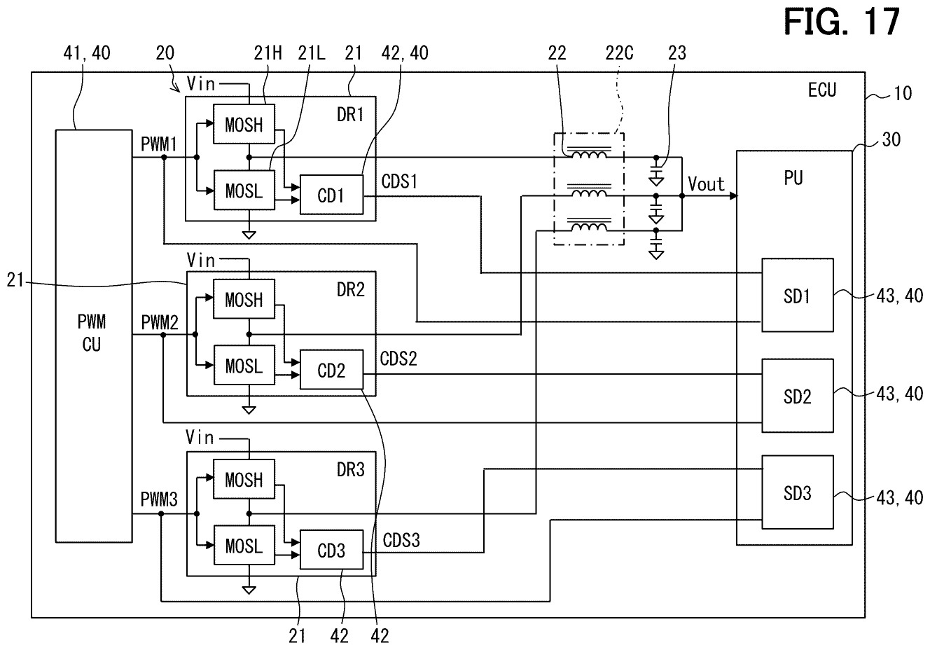

As shown in FIG. 17, the short circuit detector 43 may be provided in the processor 30. By providing the short circuit detector 43 within the processor 30, the configuration of the control device 10 can be simplified compared to a configuration using discrete components. Moreover, the short circuit detector 43 can be constructed inexpensively.

### Fifth Embodiment

A second embodiment is a modification of the preceding embodiment as a basic configuration and may incorporate description of the precedent embodiments. In the preceding embodiments, the short circuit detector is provided separately from the other elements that configure the control device. Alternatively, the short circuit detector may be provided integrally with other elements that constitute the control device.

### Effects of Load Fluctuations

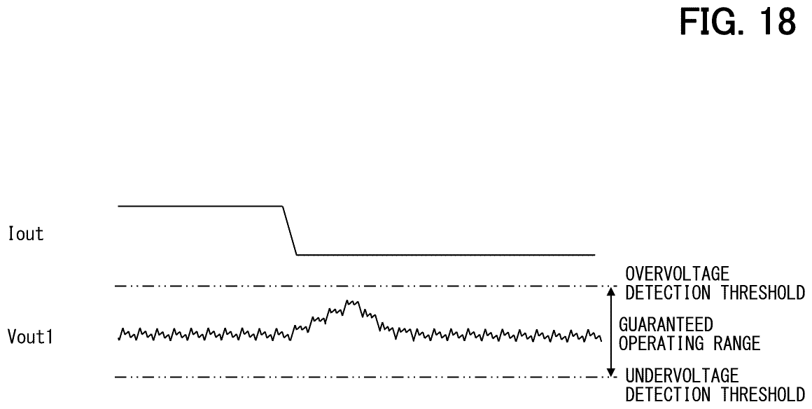

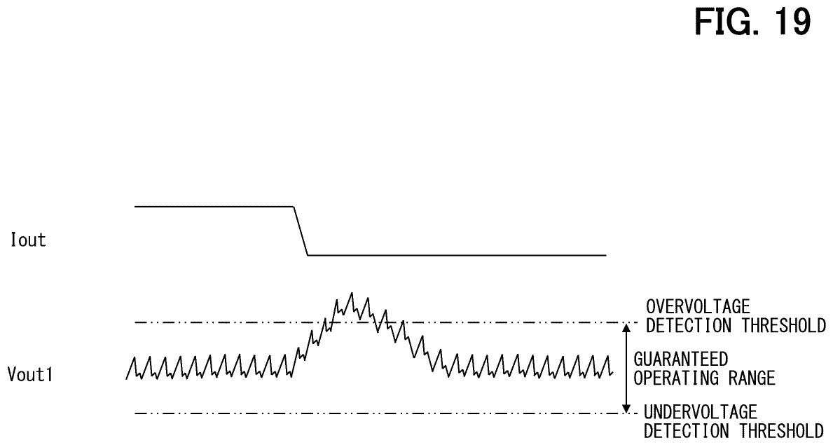

FIGS. 18 and 19 show the influence of load fluctuations in a reference example in which the control described below is not executed. FIG. 18 shows the Iout waveform and Vout1 waveform in a normal state. FIG. 19 shows the Iout waveform and the Vout1 waveform when a short circuit occurs between the inductors. FIGS. 18 and 19 show the time of switching from high load process to low load process. Iout is a current consumption of the processor 30.

In the normal state shown in FIG. 18, even if the current consumption Iout fluctuates suddenly, that is, even if the load fluctuates suddenly, the output voltage Vout1 does not exceed the guaranteed operating range of the processor 30. However, in the case of the short circuit between the inductors shown in FIG. 19, the short circuit between the inductors reduces the number of phases that act as the coupled inductor 22C by one. That is, the effective inductance increases, and the ability of the output voltage Vout1 to follow the load response deteriorates. Due to the deterioration of the load fluctuation characteristic in this way, there is a risk that the output voltage Vout1 will exceed the guaranteed operating range of the processor 30.

In the reference example, unlike the control device 10 shown in the present embodiment, when an inter-inductor short circuit occurs, the processor 30 does not execute processing in response to the occurrence of the short circuit. Therefore, in cases where the load changes suddenly, such as when switching from an automatic driving mode to a manual driving mode, there is a risk that the processor 30 may malfunction.

### Process Performed by Processor

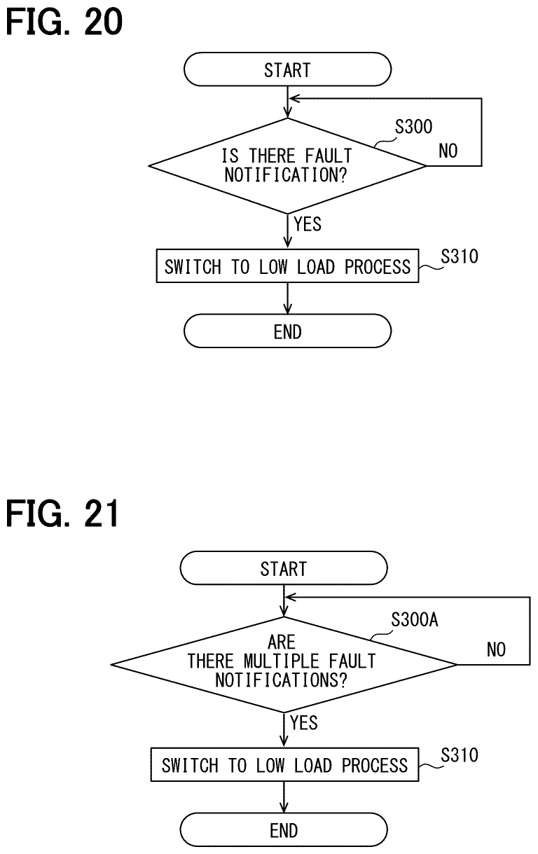

FIG. 20 is a diagram showing a part of process executed by the processor in the control device according to the present embodiment. When the processor 30 of the control device 10 is powered on and started up, for example, the processor 30 executes the process shown in FIG. 20.

The processor 30 determines whether there is a fault notification from the short circuit detector 43 (step S300). The processor 30 determines whether a fault notification signal indicating the short circuit between the inductors has been received. When no fault notification is received, the process of step S300 is repeated.

When the fault notification is received, the processor 30 switches to the low load process (step S310) and ends the series of processes. When the high load process is being executed, the processor 30 executes the low load process in step S310. When the low load process is being executed, the processor 30 maintains the low load process by the process in step S310. The processor 30 maintains the low load process until, for example, the fault notification is canceled. The other configurations are the same as those described in the previous embodiment.

### Overview of Fifth Embodiment

As illustrated in the example, when the processor 30 receives a fault notification from the short circuit detector 43, the processor 30 may reduce the processing load compared to before receiving the fault notification. This suppresses sudden fluctuations in the load when a short circuit occurs between the inductors. Therefore, even if the load fluctuation characteristics of the multiphase power supply 20 deteriorate due to a short circuit between the inductors, the output voltage can be prevented from exceeding the guaranteed operating range of the processor 30.

### Modification Example

As shown in FIG. 21, when a plurality of short circuit detectors 43 detect an inter-inductor short circuit, the processor 30 may determine that the coupled inductor 22C is short-circuited. In FIG. 21, the processor 30 executes the process of step S300A instead of the process of step S300. In S300A, when there are multiple fault notifications, that is, when the processor 30 receives multiple fault notification signals indicating an inter-inductor short circuit, it determines that an inter-inductor short circuit has occurred. Then, the process of step S310 is executed.

An inter-inductor short circuit occurs, for example, between two adjacent inductors 22 (coils 25). In a configuration in which short circuit detectors 43 are individually provided for each phase, when a short circuit occurs between two inductors 22, for example, two fault notifications are output to the processor 30 at overlapping times. When the processor 30 receives the two fault notifications, it determines that an inter-inductor short circuit has occurred. Since an inter-inductor short circuit is determined based on the results of the multiple short circuit detectors 43, erroneous detection can be suppressed. The process of step S300A is not limited to being combined with step S310.

### Other Embodiments

The disclosure in this specification and drawings is not limited to the exemplified embodiments. The disclosure encompasses the illustrated embodiments and modifications by those skilled in the art based thereon. For example, the disclosure is not limited to the combinations of components and/or elements shown in the embodiments. The disclosure may be implemented in various combinations. The disclosure may have additional portions that may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. Some aspects of the disclosed technical scope are indicated by the recitations of the claims, and should further be construed to include all modifications within the meaning and scope equivalent to those recitations.

The disclosure in the specification, drawings and the like is not limited by the description of the claims. The disclosures in the specification, the drawings, and the like encompass the technical ideas described in the claims, and further extend to a wider variety of technical ideas than those in the claims. Therefore, various technical ideas can be extracted from the disclosure of the specification, the drawings and the like without being limited to the description of the claims.

When an element or a layer is described as “disposed above” or “connected”, the element or the layer may be directly disposed above or connected to another element or another layer, or an intervening element or an intervening layer may be present therebetween. In contrast, when an element or a layer is described as “disposed directly above” or “directly connected”, an intervening element or an intervening layer is not present. Other terms used to describe the relationships between elements (for example, “between” vs. “directly between”, and “adjacent” vs. “directly adjacent”) should be interpreted similarly. As used herein, the term “and/or” includes any combination and all combinations relating to one or more of the related listed items. For example, the term A and/or B includes only A, only B, or both A and B. The description of A and/or B means at least one of A and B.

Spatial relative terms “inside”, “outside”, “back”, “bottom”, “low”, “top”, “high”, etc. are used herein to facilitate the description that describes relationships between one element or feature and another element or feature. Spatial relative terms can be intended to include different orientations of a device in use or operation, in addition to the orientations depicted in the drawings. For example, when the device in the figure is flipped over, an element described as “below” or “directly below” another element or feature is directed “above” the other element or feature. Therefore, the term “below” can include both above and below. The device may be oriented in the other direction (rotated 90 degrees or in any other direction) and the spatially relative terms used herein are interpreted accordingly.

Although the example in which the device includes at least the PWM control unit 41, the current detector 42, and the short circuit detector 43 has been shown, the device is not limited to this configuration. The device may not include the PWM control unit 41 but may include the current detector 42 and the short circuit detector 43.

As described above, when a short circuit occurs between the inductor 22 of any phase and the inductor 22 of other phase, current flows through the inductor 22 of the any phase even during the on period of the driver 21 of the other phase, and the differential value corresponding to the any phase becomes positive and greater than or equal to the threshold value. Therefore, for example, the off period of the driver 21 in any phase may be detected based on a PWM signal or an internal timer, and when the differential value corresponding to any phase during this off period is positive and equal to or greater than the threshold value THd, it may be determined that an inter-inductor short circuit has occurred between phases including the any phase.

What is claimed is:

1. A control device, comprising:
a processor with a memory storing computer program code executable by the processor, the processor configured to cause the control device to:
output a control signal to a driver of a multiphase power supply having a plurality of phases each including a driver and an inductor, the inductor of each phase being configured by a coupled inductor, and control an on/off of the driver;
detect a current flowing in the driver;
detect an inter-inductor short circuit of the coupled inductors based on a switching cycle of the driver and a current value detected by the current detector; and
determine that an inter-inductor short circuit occurs between phases including a given phase when a differential value of the current value corresponding to the given phase is positive and greater than or equal to a threshold value during an off period of the driver in the given phase.

2. The control device according to claim 1, wherein
the processor is further configured to cause the control device to determine whether the short circuit between the inductors occurs based on number of times the differential value becomes positive and equal to or greater than a threshold value during one switching cycle.

3. The control device according to claim 1, wherein
the threshold value is a predetermined value that is greater than the differential value corresponding to any of the phases when the drivers of the phases other than the arbitrary phase are turned on in a state in which no short circuit occurs between the inductors.

4. The control device according to claim 3, wherein
the processor is further configured to cause the control device to determine whether the differential value is positive and equal to or greater than a threshold value, using an average value of the differential value over a predetermined period shorter than one period of the switching cycle.

5. The control device according to claim 2, wherein
the processor is further configured to cause the control device to detect one period of the switching cycle based on the control signal.

6. The control device according to claim 1, further comprising,
a multiphase power supply, wherein
the processor is further configured to cause the control device to operate by receiving power from the multiphase power supply.

7. The control device according to claim 6, wherein
the processor is further configured to cause the control device to, when the short circuit detector determines that a short circuit occurs between the inductors, notify the processor of a fault notification, and
upon receiving the fault notification, reduce a processing load compared to before receiving the fault notification.

8. A control device, comprising:
a control unit configured to output a control signal to a driver of a multiphase power supply having a plurality of phases each including a driver and an inductor, the inductor of each phase being configured by a coupled inductor, and control an on/off of the driver;
a current detector configured to detect a current flowing in the driver; and
a short circuit detector configured to detect an inter-inductor short circuit of the coupled inductors based on a switching cycle of the driver and a current value detected by the current detector, wherein
the short circuit detector determines that an inter-inductor short circuit occurs between phases including a given phase when a differential value of the current value corresponding to the given phase is positive and greater than or equal to a threshold value during an off period of the driver in the given phase.

9. The control device according to claim 8, wherein
the short circuit detector determines whether the short circuit between the inductors occurs based on the number of times the differential value becomes positive and equal to or greater than a threshold value during one switching cycle.

10. The control device according to claim 8, wherein
the threshold value is a predetermined value that is greater than the differential value corresponding to any of the phases when the drivers of the phases other than the arbitrary phase are turned on in a state in which no short circuit occurs between the inductors.

11. The control device according to claim 10, wherein
the short circuit detector determines whether the differential value is positive and equal to or greater than a threshold value, using an average value of the differential value over a predetermined period shorter than one period of the switching cycle.

12. The control device according to claim 9, wherein
the short circuit detector detects one period of the switching cycle based on the control signal.

13. The control device according to claim 10, wherein
the number of the short circuit detectors is one less than the number of the drivers.

14. The control device according to claim 8, further comprising,
a multiphase power supply, and
a processor that operates by receiving power from the multiphase power supply.

15. The control device according to claim 8, wherein
the short circuit detector is provided in the control unit.

16. The control device according to claim 14, wherein
the short circuit detector is provided in the driver.

17. The control device according to claim 14, wherein
the short circuit detector is provided in the processor.

18. The control device according to claim 14, wherein
when the short circuit detector determines that a short circuit occurs between the inductors, the short circuit detector notifies the processor of a fault notification, and
upon receiving the fault notification, the processor reduces a processing load compared to before receiving the fault notification.

19. The control device according to claim 14, wherein
the processor determines that an inter-inductor short circuit occurs when a plurality of the short circuit detectors detect an inter-inductor short circuit.
